(19) United States
(12) Patent Application Publication
(10) Pub. No.: US 2010/0070408 A1
(43) Pub. Date: Mar. 18, 2010

(54) system and method for providing secondary financing

(76) Inventors: Tony Diaz, Upland, CA (US); Lauren Uribe, Upland, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/538,572

(22) Filed: Aug. 10, 2009

Related U.S. Application Data
(60) Provisional application No. 61/087,402, filed on Aug. 8, 2008.
(60) Provisional application No. 61/114,504, filed on Nov. 14, 2008.
(60) Provisional application No. 61/209,737, filed on Mar. 9, 2009.

(51) Int. Cl. G06Q 40/00

(52) U.S. Cl. 705/39

(57) ABSTRACT

The present invention provides secondary financing, and financing assistance, to defray the need for increased buyer income or higher home valuations. Thus, the present invention provides a system and method that allows for the access and securing of third party loans for secondary financing to enable the purchase of a primary loan of greater value, and for a revolving line of credit and funds to replenish the third party loans.

### CROSS-REFERENCE TO RELATED APPLICATIONS

This application claims priority to U.S. Provisional Patent Application Ser. No. 61/087,402 entitled “System and Method for Subsidizing Loan Down-Payments” filed on Aug. 8, 2008 in the names of inventors Lauren Uribe and Denise Block, to U.S. Provisional Patent Application Ser. No. 61/114,504 entitled “Apparatus, System and Method of Recapturing Value in a Real Estate Short Sale” filed on Nov. 14, 2008 in the names of inventors Lauren Uribe and Denise Block, and to U.S. Provisional Patent Application Ser. No. 61/209,737 entitled “System and Method for Providing Secondary Financing” filed on Mar. 9, 2009 in the names of inventors Tony Diaz and Lauren Uribe, each of these disclosures being incorporated by reference as if set forth in their entirety herein.

### FIELD OF THE INVENTION

The present invention is directed to a system and method for loan generation and, more particularly, to a system and method for the generation of a loan based upon a secondary financing.

### BACKGROUND OF THE INVENTION

It is well understood that coming up with the money for a traditional down payment of twenty (20%) percent is often the largest hurdle facing first time home buyers. Fortunately, there is help available in the form of down payment assistance. Many states have set up agencies to provide special programs to help potential first time buyers overcome the obstacles in buying their first home. For example, many states offer outright cash grants for the down payment, while others will provide a low or zero interest loan to cover the down payment. In most instances, these down payment assistance programs make it possible for first time home buyers to afford a mortgage when they would not be able to do so the conventional way.

However, recently the availability of down payment assistance has become limited, both due to legal conditions, public perception, and the economic climate. However, the need to address the issues typically addressed by down payment assistance programs, namely, for example, an inability of a buyer to qualify for a home loan, or the inability of a home to provide a sufficient valuation to serve as sufficient collateral for, for example, a refinance loan or an initial home loan.

Thus, there exists a need for a system and method that allows for the access and securing of third party loans for secondary financing to enable the purchase of a primary loan of greater value, and for a revolving line of credit and funds to replenish the third party loans.

### SUMMARY OF THE INVENTION

The present invention provides secondary financing, and financing assistance, to defray the need for increased buyer income or higher home valuations. Thus, the present invention provides a system and method that allows for the access and securing of third party loans for secondary financing to enable the purchase of a primary loan of greater value, and for a revolving line of credit and funds to replenish the third party loans.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an exemplary embodiment of aspects of the present invention;

FIG. 2 illustrates an exemplary embodiment of aspects of the present invention; and

FIG. 3 illustrates an exemplary embodiment of aspects of the present Invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in financial instruments systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention provides access and securing of secondary financing, such as third party loans, gifts, and the like, which may act as equity on the purchase of a loan. This secondary financing enables loan modifications and short sales, as discussed herein throughout. In an embodiment of the present invention, a no-cost loan of a certain monetary value may be provided as a secondary loan on a loan of a greater value. Such a loan is made to assist families and individuals with the purchase or refinance of a home or other asset when the funds necessary to close the full leverage amount(s) do not exist, are insufficiently collateralized, or are otherwise insufficient. Users of such loans may also have other assets which may not be classically considered as equity, or may not be in a position to generate cash funds from other owned assets or equities.

The present invention may help create more qualified buyers that currently do not have a sufficient down payment in hand, or who do not hold sufficient equity in a home, or who own homes that have decreased in value, but could otherwise qualify for a loan. The present invention may also create stabilization of comparable sales within communities that may become devalued because of bank owned or foreclosed properties. The present invention may also offer support and training to individuals before and after they purchase a home, to educate the asset purchaser to better manage finances. The present invention may also create greater home ownership, thus reducing the amount of standing inventory, generating more property taxes and creating more jobs which, in turn, may further stimulate the housing market as a whole.

The present invention may also promote affordable housing by providing secondary financing assistance to individuals and families who otherwise qualify, and that have a limited down payment. The present invention may provide borrowers with a catch-up from a limited down payment to twenty (20%) percent towards the down payment on an asset, such as a home. For example, in an exemplary embodiment, the loan originator funds a line of credit (LOC) to a participating nonprofit that in, in turn, may fund a no interest, no payment, and no cost loan to a borrower. Upon the close of escrow to the borrower, the seller of the asset may agree to participate by providing a LOC to the participating non-profit, to insure that the funds provided will be available for other individuals and families purchasing a home in the future. The seller's participation replenishes a blind mix pool of funds thus making the program entirety self funded. The interest of the note or instrument embodying the secondary loan may be assigned. Upon repayment of the secondary loan, the participating non-profit may then forward the proceeds minus a servicing fee. The note or instrument embodying the secondary loan may be assigned to the loan originator or, for example, any party with an interest in the transaction other than the buyer.

In an embodiment of the present invention, loans are made for the purpose of enabling at least a primary loan of greater value. These secondary loans may not require monthly interest and principal obligations. These loans may also not include any costs associated with closing or maintaining the loan. There may also be no prepayment or foreclosure fees or penalties. In essence, the loans may be of no cost to the borrower. A borrower of such a loan may be required to become a “qualified borrower”. Such a qualified borrower may have to have a certain level of credit and/or down payment contribution. Such limits may be a blended third party credit score of over 700. Other loans may only require a blended third party credit score of over 650, for example. A qualified borrower may also be required to show an employment history, submit to a criminal background check, provide proof of citizenship, provided federal and state tax returns, and submit to medical examination, for example, or with other criteria as known in the art.

Once a borrower becomes a qualified borrower, she may additionally be required to attend training and education classes aimed at developing financial awareness. The programs include home ownership education and credit awareness programs. These programs may be required before and after purchase and may be used to assess the qualifications of the borrower. The rate of the buyer's education and credit awareness program may be at least $1,500, for example. This cost may be paid to a participating non-profit by the seller at the close of escrow, for example.

In an embodiment of the present invention, the secondary loan may be a loan with a term of up to 30 years, including fifteen or twenty years, for example, and valued at up to twenty percent (20%), less the buyer's available down payment, of the total value of the loan for which the secondary loan is being applied. The maximum combined loan-to-value (CLTM) of the primary loan to the asset may be up to 100%, or 105%, for example. The loan may net require monthly payments and may not include any pre-payment penalties. The principal of the down payment loan may be due at the close of the fifteenth year (15th) and may further require the payment of loan servicing fees. The secondary loan may also be due upon demand if the borrower sells the property, refinances, or stops occupying the residence as their primary residence. In the event such a property is transferred through an estate, charitable gift, or other like transaction, neither the Secondary loan nor the shared appreciation component may be due at the time of such a transfer. The borrower may also be responsible for shared appreciation in the property. The proceeds generated by the secondary loan may be further placed in escrow and secured by a subordinate trust deed. There may also be a fee associated with origination of the loan, such as for example. $1,000.

The principal of the down payment loan may be due at the close of the fifteenth year (15th) and may further require the payment of loan servicing fees of up to twenty percent (20%) of the down payment loan amount. The down payment loan may also be due upon demand if the borrower sells the property, refinances, or stops occupying the residence as their primary residence. In the event such a property is transferred through an estate, charitable gift, or other like transaction, neither the down payment loan nor the shared appreciation component may be due at the time of such a transfer.

In an embodiment of the invention, a borrower may be using a secondary loan for use with a mortgage on a home. The primary mortgage on the home and property that the borrower wishes to purchase may be required to be a full documentation, fixed-rate product, with no balloon due prior to the 15 year term of the down payment loan, for example. Although fixed-rate interest only products may be used, the length of the fixed payments should exceed at least about 5 years while the rate remains fixed for the life of the loan.

When used for the purchase of a home eligible property may include single family homes, town homes and condominiums. The property or properties of interest to the borrower may be required to be in “good” condition. The condition of the property may be ascertained through the use of a third party home inspector or property appraiser, for example. The physical condition of the home and the conditions of adjacent properties may be factored into the condition of the property. Good versus poor conditions may be subjective and may be used as is known by those skilled in the art. Depending on the condition of the home and its age and construction type, the selling party may be required to provide at least a one year home warranty program.

The providing of a secondary loan may relieve the borrower of having to further acquire personal mortgage insurance (PMI). Thus, the present invention allows for substantial cost savings to the borrower and allows funds that may otherwise flow to an insurance carrier to be applied to the primary loan holder.

The shared appreciation component of the present invention is coincidental to the rise in the purchased asset's value, if any. By way of non-limiting example only, at anytime after five (5) years from the date of the origination of the down payment loan, if the borrower ceases to claim the purchased home as the borrower's primary residence, the entire unpaid principal balance of the down payment loan plus twenty (20%) percent of the appreciated value of the property and/or home, may be immediately due and payable as of the date borrower ceases to reside at the property and/or home. This equity stake in the borrower's asset may be secured through the use of a note or trust deed or other legal interest. The equity stake created by the secondary loan may be subordinate to the primary loan.

For example, the borrower may have obtained a secondary loan thirty five (35) years ago and would have already satisfied the loan amount of the secondary loan and the associated fees and costs required at the end of the term. The fees and costs might include a ten (10%) percent deferred loan servicing fee and the fees of $1,500 required for the educational classes. Upon the sale of the borrower's residence, the borrower would be required to pay the shared appreciation component to originator of the secondary loan.

In an additional exemplary embodiment, the present invention may be used with regard to short sales. A short sale is a term that is used to describe a sale that occurs in which the proceeds of the real estate sale fail to reach the balance owed on the property sold. Typically, in such a circumstance, the party to which the balance is owed on the property, namely a bank or mortgage lender in a typical embodiment, agrees to a discount from the loan balance due based on a financial hardship on the part of the seller of the property. In most cases of a short sale, upon execution of the sale, the debtor turns over the full proceeds of the sale to the lender, in full satisfaction of the debt owed. In certain circumstances however, the settlement is not deemed to constitute payment in full, and the debtor owes a deficiency balance for payment at some time in the future. Frequently, such as in a poor real estate sales climate, the amount owed constitutes less than the actual value of the home, and it is in such circumstances that the lender deems the short sale value as payment in full of the outstanding loan value. Similarly, a short sale will often be allowed to proceed if the lender believes it will result in a smaller financial loss than allowing a foreclosure. In such cases, for the borrower, the advantage of a short sale includes, for example, avoidance of having a foreclosure negatively affect the borrower's credit history, as well as at least partial control of any deficiency balance. Thus, a short sale merely constitutes a sale of a debt, most typically on a piece of real estate, which is short of the full debt amount.

Needless to say, lenders typically have short sales negotiated by, for example, a loss mitigation group. This is, in part, due to the fact that absent any assurance that the lender will be able to issue a new loan with respect to the same property, the lender is most likely to experience at least some loss on the subject property sale. However, the present invention provides improved loss mitigation, at least in that the present invention provides that the buyer in the short sale transaction receives his or her loan from the lender to whom the seller of the property's debt is due. Thus, the present invention provides greater control for lenders, at least in that greater flexibility is provided in allowable short sale values, due, in part, to the fact that the lender is assured of replacing the loan being fulfilled for a deficient value with an additional loan through which the value, at least over some period of time, may be mostly recouped.

Thus, the present invention provides a short sale mechanism whereby lien holders against a property may be provided with the opportunity to loan the buyer of a short sale property money, with which money the seller of the short sale property may propose to pay on that seller's balance to the lender. Needless to say, in light of the disclosure herein, such offers may be made in relevant percentages in instances wherein multiple lien holders have lent money to a seller of a short sale property, or may be offered in turn to the first position lien holder, followed by the second position lien holder, and so on in the event of a short sale. Thus, although the lender's interest rate and other factors may be moderately affected by exposing the subject property to the short sale, the lender may be made whole to greater effect than is typically the case in current short sales. Such a short sale may be configured by having the existing lender finance the new first loan for the buyer. Alternatively, two different financial institutions may be involved, such as a first institution as the existing lender and a new institution as the new first mortgage holder.

Of course, the present invention not only lowers risk and assures increased value to the lender, but additionally is highly likely to expedite the current time frame for approval of short sales. For example, short sales may, at present, take up to one year or more for the lender to approve the short sale in light of the deficient balance being received by the lender. However, in event the lender was assured of reassuming the first, or a primary, lien holder position with an outlook of receiving substantial value in return for issuing the loan to the buyer in the short sale, the lender would be much more likely to more expediently approve the short sale.

Ultimately, the present invention may provide multiple, parallel, and/or hybrid solution paths, working in conjunction with at least consumer-direct originators and owners/servicers of ones and/or pools of non-performing and quasi-performing mortgage loans. This is achieved through education, by determining a fair and equitable solution for all involved parties, and following the same or a similar methodology, be it for a note modification, a refinance, or a short sale, for example.

For example, once an appraised market value for a property at issue has been determined, the present invention increases a borrower's qualifying power. The present invention may preferably provide software, accessible to all involved parties, associated with processors at at least two networked nodes, wherein such software may preferably include underwriting criteria across multiple lenders as associated with the lending program discussed herein throughout, as discussed further herein below. A new, performing first trust deed note may be provided pursuant to acceptable circumstances under the underwriting criteria correspondent to at least the issuer of the first note, wherein the lender/owner/servicer may be required to forgive a portion of the newly appraised value to comply with all relevant, such as FNMA and FREDDIE MAC, guidelines as to the maximum loan amount Total Loan To Value (TLTV)/Current Loan to Value (CLTV).

The present invention, in order to perform the aforementioned methodologies, may be provided by a network of one or more non-profit entities that provide secondary financing correspondent to the first note, and that provide, in conjunction with such secondary financing, education including, for example, credit awareness, HUD approved education, and/or yearly performance verifications. Such network is preferably interconnected, via the aforementioned networked nodes, to the software of the present invention, and thereby the aforementioned education and verification, as well as counseling, tracking, and the like, may be available remotely and/or online, to all involved parties. The secondary financing of the present invention may provide the borrower with a subordinate loan, such as 20%, or slightly less, of the value of the subject property, having no cost, no interest and no payments, for a given preferred term, such as for 30 years as discussed hereinabove. By removing the typically required mortgage insurance using this “no payment second,” the borrower's ability to qualify may greatly increase the available amount of the first, or primary, loan. The first note may thus be readily sold after scheduled payments have successfully been made by the homeowner, and additionally, the first note becomes a performing asset, whereby timely payments are made by the borrower without the typically added burden of mortgage insurance, a for-payment second mortgage, or the like. Thereby, the lengthy short sale, and the least-desired, for all parties, foreclosure discussed herein throughout may be remedied or avoided.

The increased stability of the present invention may be enabled through the provision of not only the aforementioned secondary financing, but additionally the aforementioned education and credit counseling/restoration (pre- and post-purchase), yearly verification, principal balance reduction and non-profit participation, as well as full documentation review, debt consolidation, equity share, and Community Reinvestment Act (CRA) credit to the lender. And, of course, the secondary financing at no cost to the borrower bridges any gap between an original loan amount and a buyer's current qualifying loan amount.

The present invention may, in order to provide parallel loss mitigation solutions, such as for foreclosure, short sale, loan modification, or similar circumstances, require the servicer/owner/lender of the first note to provide a line of credit (LOC) to the participating non profit at close of escrow, thereby allowing for the program to be self funded, and thus, for example, allowing the no-cost second to be provided with a new, fully underwritten first deed. This creates a stronger, performing first deed of trust, reduces the write down costs to the lender, and increases the probability that the second deed of trust will generate a meaningful return, at least including the opportunity for an equity share. The second deed of trust is preferable for all parties, at least in that: the low, long term rate of the second is more affordable than rental housing costs; allowing credit of borrower to become deficient may preclude that borrower from subsequently buying or renting; buyers in some state of default are typically not able to pay moving or attendant relocation costs; the longer the second is in good standing, correspondent to the first being maintained in good standing, the greater the probability that the second will increase in value over time, thereby providing a two-fold benefit (the improved performance on the first, and the climbing value/profit in the second) to the lender.

The present invention allows for the secondary note to be assigned to the provider of the LOC as collateral, to the first holder, to an exiting first holder, or to the original second trust deed. Further, provision of the LOC may be made contingent on a buyer having some percentage of funds to put down on the first note, as will be understood by those skilled in the art. The present invention may thus include an equity share component after a given time period of payments on the first, such as after the 5th year. However, such equity share may be limited based on the original percentage for which the second accounts. For example, if the second is 15% of total value, a maximum appreciation share may be limited to 15%.

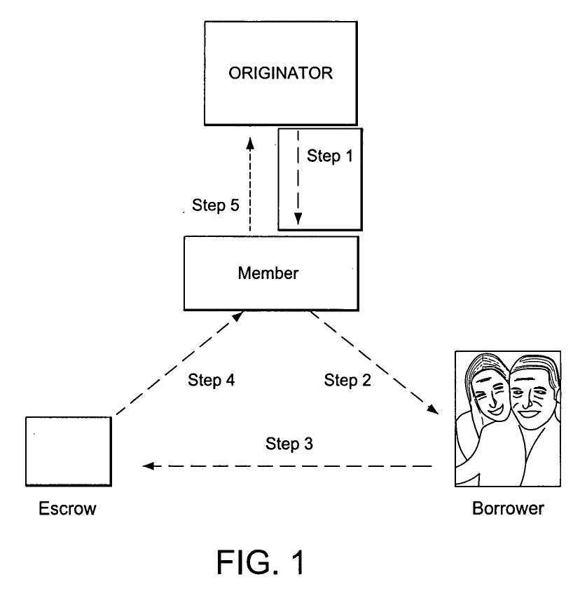

In the exemplary, embodiment of FIG. 1, at Step 1, an originator may fund a non-profit member, to enable the non-profit to make the no, or low, cost second at Step 2. The borrower has received a first mortgage from the lender/servicer/owner shown, and, at Step 3, may thus offer the no-cost second, as well as any required monies down, to the lender/servicer/owner to improve the quality of the first loan, which first loan is thus based on an “actual,” current appraisal, rather than an inflated one or one based on a prior first loan. At Step 4, the lender/servicer/owner returns a LOC, based on, for example, escrow funding from the closing, to the non-profit, and in addition returns a servicing fee and/or educational contribution fee to assist the non-profit in buttressing the likely success of the first from the lender/servicer/owner. At Step 5, the LOC returns to the originator from the non-profit, with some or the entire servicing fee. It will be understood by those skilled in the art that the present invention includes each of these discrete steps, as well as the performance of the steps in the aggregate.

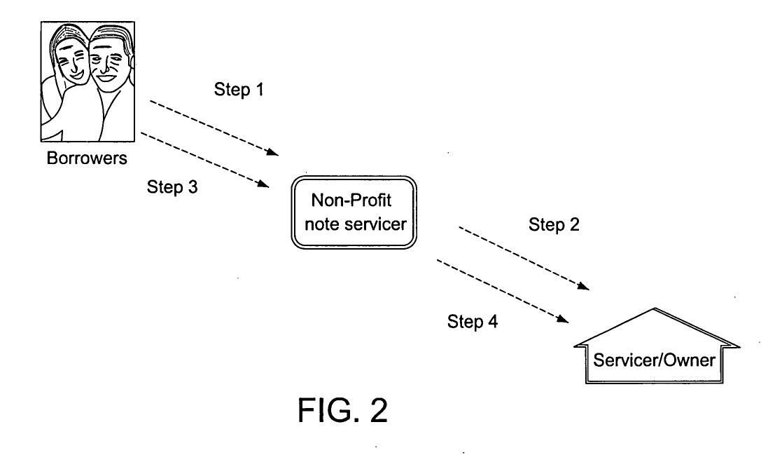

FIG. 2 illustrates the interaction of the Borrower, non-profit and the lender/servicer/owner. As illustrated, at Step 1, the borrower owes the second note to the non-profit, and at Step 3, the borrower makes payments on amounts outstanding. At Step 2, the non-profit securitizes its LOC by offering its second note as collateral, and at Step 4 the non-profit repays its LOC to the tender/servicer/owner, withholding the servicing and/or educational fees. Thus, the present invention may preferably provide the aforementioned software interconnecting all parties, whereby payments, LOCs, documentation, and counteroffers may be uniformly made via one online system.

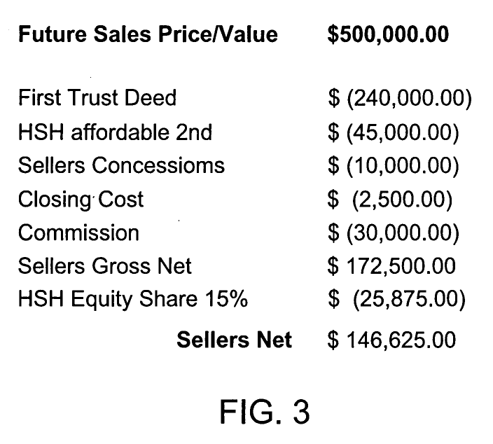

As shown in the chart of FIG. 3, as the borrower makes payments on the first loan, the buyer builds equity. The second obtains a portion of this equity in payment of the secondary note, and, upon sale or payoff, this amount is realized. Thus, the present invention may necessitate that the software associated with the one or more networked processors of the present invention provide a future net present value of the subject property, in order to insure that the equity necessary to the ultimate performance under the secondary note will actually be available. Thus, as illustrated in FIG. 3, the software may take a present appraisal, which may be greater than the actual current net present value of the subject property, and may calculate, such as using the guidelines apparent to those skilled in the art, forward to a future net present value. Needless to say, if the borrower's qualifying first note amount is less than the future net present value, the software should instruct that the first loan should be denied.

The present invention may be used in “real time” and allow borrowers, sellers and primary loan originators access to a system which allows for the exchange of information and “real time” loan verification or pseudo-verification, such as by electronic communication through the system with an underwriter, or with typical underwriting criteria, or with multiple different underwriting criteria perhaps resulting in multiple loan options, and origination. A host system may execute computer instructions for performing loan originating functions. The system may include one or more user stations through which users at one or more geographic locations, which, as used herein, may include applicants, lenders, underwriters, and business rules input persons, etc. may contact the host system. The user stations may be coupled to the host system via one or more networks. Each user station may be implemented using a general-purpose computer executing a computer program, as understood by those having skill in the art, for carrying out the processes described herein. The user stations may be, for example, personal computers, such as lap tops, desk tops, or any sort of personal digital assistant, or host attached terminals. If the user stations are personal computers, the processing described herein may be shared by a user station and the host system, for example, by providing an applet to the user station. User stations may be operated by loan originating companies, or, at least, pseudo operated by the at least one originating company offering its loan services on the system, for example. Different user types may have access to the same, or similar, graphical user interfaces, with variable access to underlying information based on permissions in accordance with user type.

The networks over which the present invention operates may be any type of known network as understood by those skilled in the art, including a wide area network (WAN), a local area network (LAN), a global network (e.g. Internet), a virtual private network (VPN), and an intranet, for example. The networks may further be implemented using a wireless network or any kind of physical network implementation as understood by those skilled in the art. In certain embodiments, a user station may be coupled to the host system through multiple networks such that not all user stations are coupled to the host system through the same network, one or more of the user stations and the host system may be connected to the networks in a wireless fashion. In one embodiment, the networks may include an intranet and one or more user stations to execute a user interface application, such as a web browser, to contact the host system through the networks. In another exemplary embodiment, the user stations are connected directly to the host system and the host system may contain memory for storing data in support of the loan originating functions. Alternatively, a separate storage device may be implemented for this purpose.

The internal storage of host system or storage device may include a data repository with data relating to loan originating and/or underwriting or business rules generally, or to a specific loan originator, and may be implemented using a variety of devices for storing electronic information. As understood by those skilled in the art, the storage may be logically addressable as a consolidated data source across a distributed environment that may include any network configuration as described herein. Stored information may be retrieved and manipulated via the host system and/or via the user stations. The data repository may include one or more databases containing loan originating opportunities, and other related information.

The host system may be implemented using one or more servers operating in response to a computer program stored in a storage medium accessible by the server. The host system may also operate as a network server to communicate with the user stations. The host system may handle sending and receiving information to and from the user stations and may perform associated tasks. The host system may also include protective measures, such as a firewall, for example, to prevent unauthorized access to the host system and enforce any limitations on authorized access.

As indicated above, processing may be shared by the user stations and the host system by providing an application to the user stations. Alternatively, the user stations may include a stand-alone software application for performing a portion or all of the processing described herein. As previously described, it is understood that separate servers may be utilized to implement the network server functions and the application server functions. Alternatively, the network server, any firewall, and any application server may be implemented by a single server executing computer programs to perform the requisite functions.

The loan origination and verification application may implement the features of the present invention for performing the loan originating activities described herein. As indicated above, the loan originating application may include a user interface for enabling one or more users to enter criteria used by the loan originating application in processing loan originating information. For example, various activities associated with loan originating may be monitored and managed by establishing threshold values defined by the users, which may be applied to loan originating and the guidelines provided by the loan originating application. These activities may be actual ongoing activities or proposed activities as described herein.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. A system for providing secondary financing in order to transfer at least one tangible property, said device comprising:
an originator to provide at least the initial funding for initiation of the transfer of the at least one tangible property to at least one buyer;
a non-profit member that is funded by said originator and funds an escrow of the transfer of the at least one tangible property;
a line of credit that is opened when the escrow of the transfer of the at least one tangible property closes;
wherein said line of credit is paid down after receiving seller proceeds from the at least one buyer at closing a subsequent one of the transfer of the at least one tangible property.

2. The system of claim 1, wherein the transfer of at least one tangible property is a short sale.

3. The system of claim 1, wherein the transfer of at least one tangible property is a loan modification.

4. The system of claim 1, wherein the transfer of at least one tangible property is a home purchase.

5. The system of claim 1, wherein the transfer of at least one tangible property is a refinance of an existing mortgage note.

6. The system of claim 1, wherein the transfer of at least one tangible property comprises no penalties to a borrower of the transfer.

7. The system of claim 1, wherein the transfer of at least one tangible property comprises no closing costs.

8. The system of claim 1, wherein the transfer of at least one tangible property comprises no loan maintenance fees.

9. The system of claim 1, wherein said escrow closes at approximately the same time as the transfer.

10. A method of securitizing a note and providing repayment during a transfer of at least one tangible property, said method comprising:
owing a note to a participating member;
assigning said note to securitize a line of credit by a participating member;
paying off said note by the buyer upon the transfer of at least one tangible property; and,
repaying said line of credit by said participating member.

11. The method of claim 10, wherein said repaying comprises withholding a service fee.

12. The method of claim 10, wherein the transfer of at least one tangible property is a short sale.

13. The method of claim 10, wherein the transfer of at least one tangible property is a loan modification.

14. The method of claim 10, wherein the transfer of at least one tangible property is a home purchase.

15. The method of claim 10, wherein the transfer of at least one tangible property is a refinance of an existing mortgage note.

16. The method of claim 10, wherein the transfer of at least one tangible property comprises no penalties to a borrower of the transfer.

17. The method of claim 10, wherein the transfer of at least one tangible property comprises no closing costs.

18. The method of claim 10, wherein the transfer of at least one tangible property comprises no loan maintenance fees.

19. An instrument for obtaining equity in real estate, said instrument comprising:
a first mortgagor that holds the first mortgage on the real estate;
a second mortgagor that holds a second mortgage on the real estate;
wherein when the borrower makes payments on the first mortgage, the borrower builds equity in the real estate and wherein the second mortgagor obtains a portion of the payments of the borrower in payment of at least a portion of the second mortgage, and realizes this payment upon sale of the equity.

20. The instrument of claim 19, wherein said sale of the equity comprises a subsequent transfer of the real estate.
